(19) United States
(12) Patent Application Publication
(10) Pub. No.: US 2010/0071004 A1
(43) Pub. Date: Mar. 18, 2010

(54) METHODS AND APPARATUS FOR PROVIDING MULTIPLE CHANNEL RECALL ON A TELEVISION RECEIVER

(75) Inventor: Robert Edward Wightman, West Yorkshire (GB)

Correspondence Address: EchoStar Technologies, L.L.C.;Legal Department, 9601 SOUTH MERIDIAN BOULEVARD, ENGLEWOOD, CO, 80112, US

(73) Assignee: Eldon Technology Limited, Steeton (GB)

(21) Appl. No.: 12/233,274

(22) Filed: Sep. 18, 2008

(51) Int. Cl. H04N 5/445

(52) U.S. Cl. 725/46

(57) ABSTRACT

The various embodiments described herein provide methods and apparatus for providing multiple channel recall on a television receiver. A television receiver stores multiple previously viewed channels for selective recall by a user. The previously viewed channels are each associated with a viewing duration of the channel. The previously viewed channels are sorted such that a user may access the channels in an order determined based on the viewing duration of each channel.

### BACKGROUND

Television receivers typically include a feature for recalling a previously viewed channel. The television receiver remembers the last previously viewed channel, which may be accessed through the recall function. Remote controls associated with television receivers include a recall button that toggles between two channels, i.e., a presently viewed channel and a previously viewed channel. Thus, a user may toggle between watching two different programs with the press of a single button. After actuation of the recall button, the presently viewed channel becomes the previously viewed channel and vice versa.

A recall button is useful for viewers that desire to alternate between watching two programs. For example, a user may toggle between channels 24 and 57 of the television receiver. However, the user is limited to alternating between the two channels. If the user switches the television receiver from channel 57 to channel 10, then channel 24 may no longer be accessed using the recall button. Rather, the recall button toggles the television receiver between channels 57 and 10 until the user switches to another channel besides 57 or 10. Thus, the user's viewing experience is limited based on the configuration of the recall button.

### BRIEF DESCRIPTION OF THE DRAWINGS

The same number represents the same element or same type of element in all drawings.

FIG. 1 illustrates an embodiment of an entertainment system.

FIG. 2 illustrates an embodiment of a screenshot of a selection menu.

FIG. 3 illustrates an embodiment of a television receiver of FIG. 1.

FIG. 4 illustrates an embodiment of a process for providing multiple channel recall on a television receiver.

### DETAILED DESCRIPTION

The various embodiments described herein generally provide apparatus, systems and methods which facilitate a user's navigation through channels of a television receiver. More particularly, the various embodiments described herein provide television receivers that store multiple previously viewed channels for selective recall by a user. A user selects one of the previously viewed channels for viewing, and the television receiver changes the outputted channel accordingly. In short, the various embodiments described herein provide multiple channel recall on a television receiver.

In at least one embodiment, the previously viewed channels are stored in a list, with each channel of the list having an associated viewing duration. The list is sorted according to the viewing durations of the previously viewed channels. The channels in the list are then accessed responsive to actuation of a recall function according to the viewing duration of each channel. In at least one embodiment, the channels are sorted from longest viewing duration to shortest viewing duration. Likewise, the channels may be sorted from shortest viewing duration to longest viewing duration.

In at least one embodiment, a television receiver outputs a selection menu that includes a plurality of previously viewed channels. The channels may be arranged according to their associated viewing duration. A user selects one of the channels from the selection menu for viewing, and a tuner of the television receiver is commanded to decode and output the selected channel.

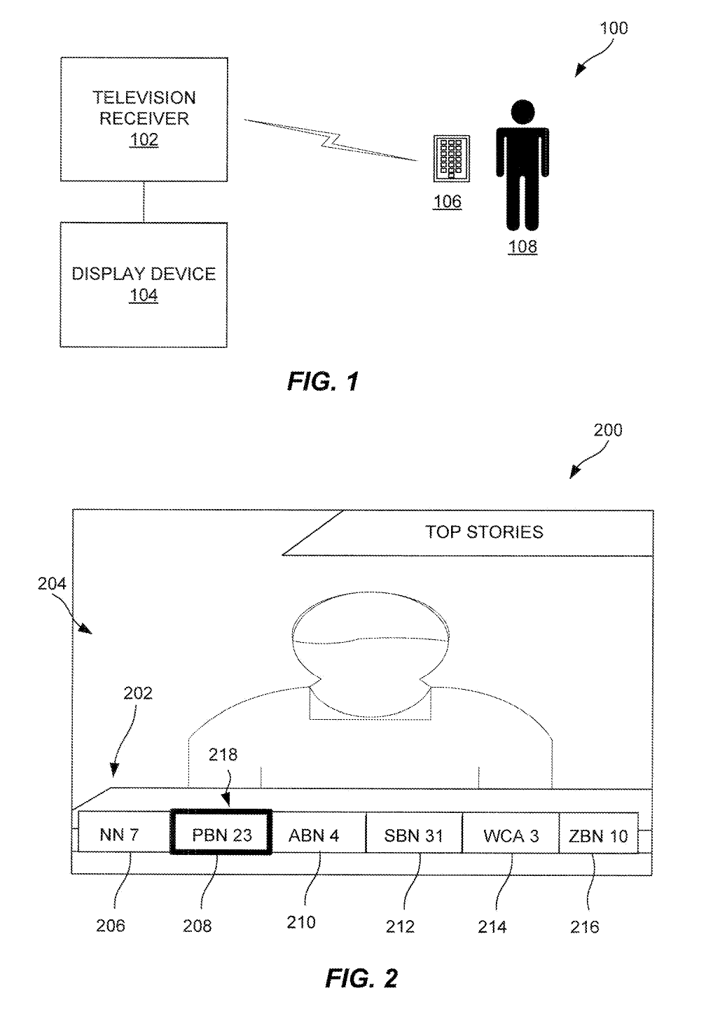

FIG. 1 illustrates an embodiment of an entertainment system 100. The entertainment system 100 presents content to a user 108. In at least one embodiment, the content presented to the user 108 includes an audio/video stream, such as a television program, movie or other recorded content and the like. The entertainment system 100 includes a television receiver 102, a display device 104 and a remote control 106. Each of these components is discussed in greater detail below. The entertainment system 100 may include other devices, components or elements not illustrated for the sake of brevity.

The television receiver 102 is operable to receive content from one or more content sources (not shown in FIG. 1), and to output the received content for presentation by the display device 104. More particularly, the television receiver 102 is operable to receive and demodulate a television signal from a programming source, such as a satellite, cable, internet, terrestrial or other type of television transmission signal. The television receiver 102 may receive an audio/video stream in any format (e.g., analog or digital format). Likewise, the television receiver 102 may output the audio/video stream for presentation by the display device 104 in any type of format. In at least one embodiment, the television receiver 102 is a set-top box (e.g., a satellite or cable television converter box), digital video recorder (DVR) or other similar device that processes and provides one or more audio and/or video output streams to the display device 104 for presentation to the user 108. The television receiver 102 may be further configured to output for display menus and other information that allow a user 108 to control the output of content by the television receiver 102. For example, as described in further detail below, the television receiver 102 may output menus of previously viewed channels to provide multiple channel recall functionality to the user 108.

The display device 104 may comprise any type of device capable of receiving and outputting a video signal in any format. Exemplary embodiments of the display device 104 include a television, computer monitor, liquid crystal display (LCD) screen, touch screen and projector. The display device 104 and television receiver 102 may be communicatively coupled through any type of wired or wireless interface. For example, the display device 104 may be communicatively coupled to the television receiver 102 through a coaxial cable, component or composite video cables, an HDMI cable, a VGA or SVGA cable, a Bluetooth or WiFi wireless connection or the like. In at least one embodiment, the television receiver 102 and the display device 104 may be integrated as a device combining the functionality of a display device and a set-top box, digital video recorder (DVR) or the like.

The remote control 106 may comprise any system or apparatus configured to remotely control the output of content by the television receiver 102. The remote control 106 may minimally include a transmitter, an input device (e.g., a keypad) and a processor for controlling the operation of the remote control 106. The remote control 106 may communicate commands to the television receiver 102 requesting to playback content, temporally move through content (e.g., fast-forward or reverse), adjust the volume, access electronic programming guides and the like. In some embodiments, the remote control 106 may additionally be configured to remotely control the display device 104. The remote control 106 may communicate with the television receiver 102 and/or the display device 104 through any type of wireless communication medium, such as infrared (IR) signals or radio-frequency (RF) signals.

The remote control 106 may include any type of man-machine interface for receiving input from the user 108. For example, the remote control 106 may include buttons for receiving input from the user 108. In at least one embodiment, the remote control 106 includes a touch pad for receiving input from the user 108. The remote control 106 may further include a trigger, utilized in association with the touch pad, for allowing the user to input information associated with the menus displayed on-screen.

During a viewing session, the user 108 requests to view one or more channels accessible through the television receiver 102. The user 108 may request to access these through a variety of techniques. Exemplary techniques for requesting to view a particular channel include directly entering a channel number, e.g., 140, utilizing a channel up/down button of the remote control 106 to navigate channels, selecting a channel in an electronic programming guide (EPG), selecting a channel from a list of favorite channels and utilizing a recall function of the television receiver 102. As the user 108 navigates through the channels of the television receiver 102, the television receiver 102 maintains a list of channels previously viewed by the user 108.

In at least one embodiment, the number of previously viewed channels stored in memory may be a pre-defined number (N). In other words, the television receiver 102 may maintain a first-in-first-out (FIFO) list in memory reflecting the last N channel changes. For example, if N is five, and the user 108 views channels 14, 57, 23, 73, 2, 6, 8, and 9, respectively, then the television receiver 102 would store 8, 6, 2, 73 and 23 in memory while the user 108 is viewing channel 9. It is to be appreciated that the contents of the FIFO memory may change each time the television receiver 102 changes channels. Thus, if the user 108 switches from channel 9 to channel 3, then the content of the memory may subsequently store 9, 8, 6, 2 and 73.

However, often a user 108 doesn't switch between five unique channels. Rather, the user 108 may repeatedly switch back to the same channel or channels during the viewing session. For example, a user 108 may initially watch channel 3, switch to channel 27, return back to channel 3, switch to channel 4, return to channel 3, switch to channel 10, return to channel 3, switch to channel 50, return to channel 3 and then switch to channel 13. If the television receiver 102 maintained a list of the last N channel changes, where N is equal to five, then channel 3 would represent three of the five previously viewed channels when the user 108 is viewing channel 13. However, in at least one embodiment, the television receiver 102 may maintain a list of N previously viewed unique channels in reverse chronological order. In the aforementioned example, the television receiver 102 may store the previously viewed channels, 3, 50, 10, 4 and 27 while the user 108 is viewing channel 13.

The list of previously viewed channels may be stored as a modified FIFO buffer. Rather than overwriting the first channel in the buffer, the television receiver 102 may overwrite the least recently accessed channel in the buffer. Thus, if a channel farther down in the buffer is subsequently accessed, the channel is moved from its previous spot to the top of the buffer, reflecting that the channel was more recently accessed than other channels within the list of previously viewed channels. In at least one embodiment, the list of previously viewed channels is embodied as a linked list, where the last entry in the list points to the first entry of the list and vice versa. Thus, a user may access channels of the linked list in a circular fashion.

In some embodiments, the list of previously accessed channels may be initialized upon activation of a new viewing session. In other words, each time the television receiver 102 powers off/on, the list of previously viewed channels may be erased. In other embodiments, the list of previously viewed channels may carry over between viewing sessions.

To recall a previously viewed channel, the user 108 actuates the recall functionality of the television receiver 102. For example, the recall function may be actuated through a button on the television receiver 102 or may be accessed through a button/switch or the like of the remote control 106. The television receiver 102 then allows the user 108 to navigate through the list of previously viewed channels to select a particular channel for viewing.

For example, the list of previously viewed channels may include channels 5, 23, 7, 15 and 55. The user 108 may initially be watching channel 9. A first press of the button switches the television receiver 102 to channel 5. A second press of the button switches the television receiver 102 to channel 23. Subsequent presses of the button likewise may switch the television receiver 102 to channels 7, 15 and 55, respectively. In at least one scenario, activation of the button while watching channel 55 switches the television receiver 102 to channel 9, which is the initially watched channel prior to activation of the recall function.

In at least one embodiment, the position of a pointer of the linked list is modified after a specified period of time. For example, the user 108 may press a button to switch the television receiver 102 from channel 9 to channel 5. Thus, a subsequent press of the button would switch the television receiver 102 from channel 5 to channel 23. However, if the user 108 waits a pre-determined time before pressing the same button again, then the television receiver 102 may instead switch from channel 5 to channel 9. This is because channel 9 is added to the head of the linked list responsive to the previous switch from channel 9 to channel 5, replacing channel 5 in the list. Thus, the linked list includes the channels 9, 23, 7, 15 and 55. Further, a pointer may indicate channel 23 as the next channel to switch to responsive to a press of a recall button. However, after the pre-determined waiting period, the pointer moves back to the first position in the linked list, such that a subsequent button press switches the television receiver 102 from channel 5 to channel 9.

In at least one embodiment, the list of the previously viewed channels is sorted according to the associated viewing durations of the channels. For example, the list may be sorted from longest viewing duration to shortest viewing duration. The sorting process may be performed by the television receiver 102 responsive to changes to the contents of the list. For example, the sorting process may occur each time a channel change is performed by the television receiver 102. Table #1 illustrates one embodiment of viewing durations for a plurality of channels viewed by the user 108 during a viewing session.

TABLE #1
Previously viewed channels

| Channel | Viewing Duration |
|---|---|
| 3 | 3:01 |
| 23 | 0:30 |
| 4 | 8:31 |
| 18 | 20:13 |
| 31 | 7:44 |
| 10 | 2:45 |

Take for example the situation where the user 108 is watching channel 10, and the list of previously viewed channels includes 3, 23, 4, 18 and 31. If the list is sorted in descending order according to viewing duration, then the order of the list will be 18, 4, 31, 3 and 23. If the user 108 switches from channel 10 to channel 23, then channel 10 will replace channel 23 in the list, and a new sorting process will be performed. Thus, the new order of the list will be 18, 4, 31, 3 and 10.

In at least one embodiment, the viewing duration is incremented each time the user 108 views the channel. For example, the user 108 initially watches channel 23 for 30 seconds as illustrated in Table #1. The user 108 subsequently switches from channel 10 to channel 23, and watches channel 23 for an elapsed duration of 15:04. Thus, when the user 108 switches from channel 23 to another channel, such as channel 18, the viewing duration for channel 23 will be incremented to 15:37, the total viewing duration of channel 23 during the viewing session. Thus, the list includes channels 3, 23, 4, 31 and 10 after the switch from channel 23 to channel 18. Further, the order of the list will be 23, 4, 31, 3 and 10.

In at least one embodiment, the television receiver 102 outputs a selection menu of previously viewed channels. The user 108 utilizes the remote control 106 to select one of the previously viewed channels for viewing. For example, the selection menu may include a numeric identifier (e.g., 1-5) identifying each of the previously viewed channels. A user 108 may then press a numeric key of the remote control 106 to select a particular previously viewed channel for viewing. The television receiver 102 then responsively tunes and outputs the selected channel for display by the display device 104. In at least one embodiment, the channels of the selection menu are arranged according to the viewing durations. In other words, the previously viewed channels are sorted according to the viewing duration of the channels.

In some embodiments, the selection menu outputted by the television receiver 102 may include a manipulatable cursor that the user 108 utilizes to select a particular channel of the selection menu. For example, the remote control 106 may include arrow keys, a touch pad or the like that the user 108 utilizes to select a particular previously viewed channel for viewing.

FIG. 2 illustrates an embodiment of a screenshot 200 of a selection menu 202. FIG. 2 will be discussed in reference to the entertainment system 100 of FIG. 1. The user 108 utilizes the remote control 106 to activate the recall function. For example, the user 108 may press a recall button of the remote control 106 or make a movement along a touch pad of the remote control 106. Responsive to activation of the recall function, the television receiver 102 outputs the selection menu 202.

The selection menu 202 is overlaid on the video data 204 of a presently viewed channel. As illustrated in the screenshot 200, the presently viewed channel is illustrated as icon 206. Similarly, each previously viewed channel is represented by an icon 208-216 associated with the channel. In some embodiments, the presently viewed channel may not be represented as an icon in the selection menu 202. The selection menu 202 also includes a cursor 218 highlighting one of the previously viewed channels. In the illustrated embodiment, a user 108 utilizes the remote control 106 to manipulate the position of the cursor 218 to select one of the previously viewed channels. For example, the user 108 may provide input to a touch pad of the remote control 106 to manipulate the cursor 218. Responsive to receiving a user selection from the selection menu 202, the television receiver 102 tunes and outputs the selected channel indicated by the position of the cursor.

In some embodiments, the television receiver 102 may change the channel responsive to movement of the cursor 218. In other words, as the position of the cursor 218 moves, the television receiver 102 switches the channel outputted for display by the display device 104. In at least one embodiment, the user 108 manipulates a position of the cursor 218 by providing a first user input, and makes a selection of a particular channel by providing a second user input. For example, a user 108 may move the position of the cursor 218 using a touch pad of the remote control 106, and the user may select a particular previously viewed channel utilizing a trigger of the remote control 106.

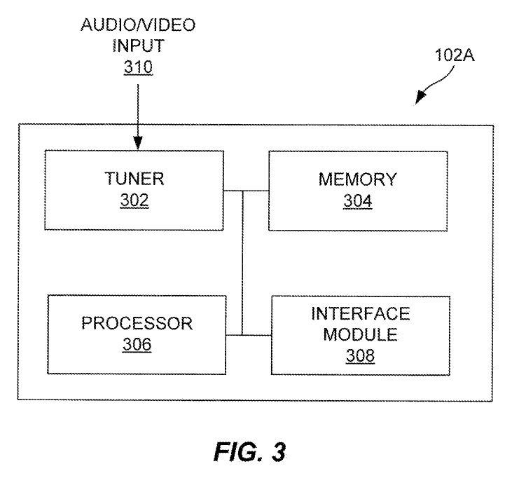

FIG. 3 illustrates an embodiment of a television receiver of FIG. 1. FIG. 3 will be discussed in reference to the entertainment system 100 illustrated in FIG. 1. The television receiver 102A includes a tuner 302, a memory 304, a processor 306 and an interface module 308. Each of these components will be discussed in greater detail below. The television receiver 102A may include other elements, components or devices which are not illustrated for the sake of brevity.

The tuner 302 is operable to receive an audio/video input 310 from a content source. More particularly, the tuner 302 receives and tunes a television signal including television programming. The tuner 302 may receive an over-the-air broadcast signal, a direct broadcast satellite signal, a cable television signal or an internet protocol television (IPTV) signal and tune the audio/video input 310 to extract the selected television programming.

The memory 304 is operable to store settings and other data of the television receiver 102A. The memory 304 may comprise any type of memory appropriate for storing data utilized to control the operation of the television receiver 102A. Exemplary memory 304 includes semiconductor random access memory (RAM), flash memory, magnetic memory and the like. The memory 304 is at least operable to store data regarding a plurality of previously viewed channels.

The processor 306 is operable to control the operation of the television receiver 102A. The processor 306 may be a single processing device or a plurality of processing devices that cooperatively operate to control the operation of the television receiver 102A. The processor 306 may include various components or modules for processing and outputting audio/video content. Exemplary components or modules for processing audio/video content include a demodulator, a decoder, a decompressor, a conditional access module and a transcoder module.

The processor 306 processes the audio/video input 310 to generate an audio/video output stream. The audio/video output stream is outputted to the display device 104 (see FIG. 1) for presentation to a user. The processor 306 may incorporate circuitry to output the audio/video streams in any format recognizable by the display device 104, including composite video, component video, Digital Visual Interface (DVI) and High-Definition Multimedia Interface (HDMI). The processor 306 may also incorporate circuitry to support multiple types of these or other audio/video formats. In at least one embodiment, as described above, the television receiver 102A may be integrated with the display device 104, and the processor 306 may be operable to control the presentation of the audio/video output stream.

The interface module 308 is operable to wirelessly receive data from the remote control 106. The interface module 308 may communicate with the remote control 106 utilizing any type of IR or RF communication link. In at least one embodiment, the interface module 308 receives a key code from the remote control 106, and responsively provides the key code to the processor 306. In some embodiments, the interface module 308 may receive positional information from a scrolling device of the remote control 106, e.g., a touch pad, scroll wheel or the like.

Some of the data received by the interface module 308 may request to change a channel outputted by the television receiver 102A. The processor 306 stores data to the memory 304 to reflect a list of previously viewed channels as well as the presently viewed channel. The user 108 then requests to activate a recall function of the television receiver 102A, e.g., by pressing a recall button of the remote control. The processor responsively switches channels according to the order of the list of previously viewed channels. For example, the user 108 may provide input to the remote control 106 to switch to a first channel of the list of previously viewed channels, e.g., by pressing a recall button of the remote control 106.

The interface module 308 receives the input from the remote control 106, and the processor 306 processes the input and responsively commands the tuner 302 to tune to the selected previously viewed channel. The processor further outputs a video signal associated with the selected one of the plurality of previously viewed channels for presentation by the display device 104. Thus, a user 108, through the improved television receiver 102A, may navigate through a plurality of previously viewed channels to experience multiple channel recall function during a viewing session. Subsequent presses of the recall button may navigate the user 108 through the channels of the list.

Those of ordinary skill in the art will appreciate that the various functional elements 302 through 308 shown as operable within the television receiver 102A may be combined into fewer discrete elements or may be broken up into a larger number of discrete functional elements as a matter of design choice. Thus, the particular functional decomposition suggested by FIG. 3 is intended merely as exemplary of one possible functional decomposition of elements within the television receiver 102A.

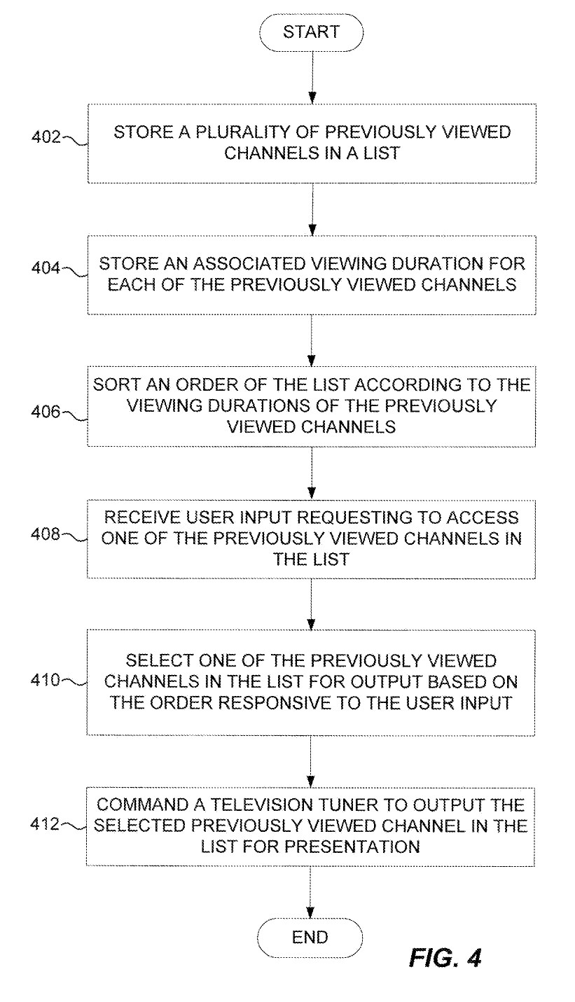

FIG. 4 illustrates an embodiment of a process for providing multiple channel recall on a television receiver. More particularly, the process of FIG. 4 provides a recall list of previously viewed channels available to a user that is ordered according to viewing durations of the channels. The process of FIG. 4 may include other operations not illustrated for the sake of brevity.

The process includes storing a plurality of previously viewed channels in a list (operation 402). Previously viewed channels may be stored in the list responsive to channel changes requested by a user. In some embodiments, channels may be replaced in a FIFO fashion. In other embodiments, the head or tail of the list may be removed responsive to additions to the list. For example, a channel change request may result in the user switching from a presently viewed channel to the channel that is the head of the list. Thus, the head of the list may be removed and the presently viewed channel may be added to the head of the list.

The process further includes storing an associated viewing duration for each of the previously viewed channels (operation 404). The process further includes sorting an order of the list according to the viewing durations of the previously viewed channels (operation 406). Any type of sorting order may be utilized depending on desired design criteria.

The process further includes receiving a first user input requesting to access one of the previously viewed channels in the list (operation 408). The process further comprises selecting one of the previously viewed channels for output based on the order of the list responsive to the first user input (operation 410). In at least one embodiment, the selected one of the previously viewed channels has the longest viewing duration of the plurality of previously viewed channels in the list. The process further comprises commanding a television tuner to output the selected one of the previously viewed channels in the list for presentation by a display device responsive to the first user input (operation 412).

The process may optionally include updating the list to add the previously viewed channel responsive to the first user input. Likewise, the process may include removing the first previously viewed channel from the list. The updated list is then sorted according to the viewing durations of the previously viewed channels.

A user may provide multiple inputs to traverse the contents of the list. For example, a television receiver may receive second user input requesting to access another of the previously viewed channels in the list. Responsive to the second input, a television tuner is commanded to output a second of the previously viewed channels in the list. If the first previously viewed channel has been removed from the list, then the process may include updating the list to add the first previously viewed channel and sorting the updated list according to the viewing duration of each of the previously viewed channels in the list. Similarly, the list may be updated to remove the second previously viewed channel prior to sorting responsive to the second user input. In other words, in at least one embodiment, channels are added and removed from the list based on their status responsive to channel changes. Thus, if a television receiver switches to a particular channel, then the particular channel is no longer a previously viewed channel, but rather, the presently viewed channel. Similarly, the channel being outputted by the television receiver prior to the channel switch becomes a previously viewed channel, and, thus is added to the list of previously viewed channels.

Although specific embodiments were described herein, the scope of the invention is not limited to those specific embodiments. The scope of the invention is defined by the following claims and any equivalents therein.

What is claimed:

1. A method of providing multiple channel recall on a television receiver, the method comprising:
storing a plurality of previously viewed channels in a list;
storing an associated viewing duration for each of the previously viewed channels;
sorting an order of the list according to the viewing durations of the previously viewed channels;
receiving a first user input requesting to access one of the previously viewed channels in the list;
selecting a first of the previously viewed channels in the list for output based on the order responsive to the first user input; and
commanding a television tuner to output the first of the previously viewed channels in the list for presentation by a display device responsive to the first user input.

2. The method of claim 1, wherein the first of the previously viewed channels has the longest viewing duration of the plurality of previously viewed channels in the list.

3. The method of claim 2, further comprising:
updating the list to add a presently viewed channel responsive to the first user input; and
sorting the updated list according to the viewing durations of the previously viewed channels in the list.

4. The method of claim 1, further comprising:
receiving a second user input requesting to access another of the previously viewed channels in the list;
commanding the television tuner to output a second of the previously viewed channels in the list responsive to the second user input;
updating the list to add the first previously viewed channel; and
sorting the updated list according to the viewing duration of each of the previously viewed channels in the list.

5. The method of claim 4, wherein the list includes the second previously viewed channel prior to receipt of the second input, and wherein the method further comprises:
updating the list to remove the second previously viewed channel responsive to the second user input.

6. The method of claim 1, further comprising:
outputting a selection menu including the plurality of previously viewed channels;
wherein the first user input is received responsive to the output of the selection menu.

7. The method of claim 6, wherein the previously viewed channels in the selection menu are arranged according to the order of the previously viewed channels in the sorted list.

8. The method of claim 6, wherein receiving the first user input further comprises:
outputting a cursor within the selection menu;
receiving first user input requesting to manipulate a position of the cursor; and
receiving second user input selecting the first of the previously viewed channels associated with the position of the cursor.

9. A television receiver comprising:
a tuner that receives television programming from a programming source;
a memory that stores a plurality of previously viewed channels in a list, each of the previously viewed channels in the list including an associated viewing duration;
a processor communicatively coupled to the memory and communicatively coupled to the tuner that sorts the list according to the viewing durations of the previously viewed channels; and
an interface module communicatively coupled to the processor that communicates with an input device to receive a first user input requesting to access one of the previously viewed channels in the list;
the processor further operable to process the first user input to select a first of the previously viewed channels in the list for output based on the order responsive to the first user input, command the tuner to tune to the first of the previously viewed channels and output a video signal associated with the first previously viewed channel for presentation by the display device.

10. The television receiver of claim 9, wherein the first of the previously viewed channels has the longest viewing duration of the plurality of previously viewed channels in the list.

11. The television receiver of claim 10, wherein the processor is further operable to:
update the list to add a presently viewed channel responsive to the first user input; and
sort the updated list according to the viewing durations of the previously viewed channels in the list.

12. The television receiver of claim 9, wherein:
the interface module is operable to receive a second user input requesting to access another of the previously viewed channels in the list;
the processor operable to command the television tuner to output a second of the previously viewed channels in the list responsive to the second user input, update the list to include the first previously viewed channel and sort the updated list according to the viewing duration of each of the previously viewed channels in the list.

13. The television receiver of claim 9, wherein the list includes the second previously viewed channel prior to reception of the second input, and the processor is operable to update the list to remove the second previously viewed channel responsive to the second user input.

14. The television receiver of claim 9, wherein:
the processor is operable to output a selection menu including the plurality of previously viewed channels;
the interface module is operable to receive the first user input responsive to the output of the selection menu.

15. The television receiver of claim 14, wherein the previously viewed channels in the selection menu are arranged according to the order of the previously viewed channels in the sorted list.

16. The television receiver of claim 14, wherein the processor is operable to:
output a cursor within the selection menu;
receive first user input requesting to manipulate a position of the cursor; and
receive second user input selecting the one of the plurality of previously viewed channels associated with the position of the cursor.

17. A television receiver comprising:
a tuner that receives television programming from a programming source;
an interface module that communicates with an input device to receive commands requesting to change channels of the television programming received by the tuner;
a processor communicatively coupled to the tuner and communicatively coupled to the interface module that is operable to:
process a first user input requesting to command the tuner to switch from a first channel to a second channel;
store the first channel and an associated first viewing duration in a list;
process a second user input requesting to command the tuner to switch from the second channel to a third channel;
store the second channel and an associated second viewing duration in the list;
sort an order of the list based on the first viewing duration and the second viewing duration;
process a third user input requesting to view a previously viewed channel from the list;
select one of the first channel or the second channel based on the order of the list responsive to the third user input; and
coordinate the output of a first video signal associated with the selected one of the channels from the list for output to a display device.

18. The television receiver of claim 17, wherein the selected one of the channels comprises the first channel, and wherein the processor is further operable to:
process a third user input requesting to view another previously viewed channel from the list;
select the second channel for output based on the order of the list responsive to the fourth user input; and
coordinate the output of a second video signal associated with the second channel to the display device.

19. The television receiver of claim 17, wherein the selected one of the channels comprises the first channel, and wherein the processor is further operable to:
remove the first channel from the list responsive to the third user input;
store the third channel and an associated third viewing duration in the list responsive to the third user input; and
sort the order of the list based on the second viewing duration and the third viewing duration.

20. The television receiver of claim 19, wherein the processor is further operable to:
receive fourth user input requesting to command the tuner to switch from the first channel to another channel, the fourth user input being received an elapsed duration after the third user input;
incrementing the first viewing duration by the elapsed duration; and
storing the first channel with the incremented first viewing duration in the list responsive to the fourth user input.
